(19) United States
(12) Patent Application Publication
(10) Pub. No.: US 2006/0230428 A1
(43) Pub. Date: Oct. 12, 2006

(54) Multi-player video game system

(76) Inventors: Rob Craig, Sunnyvale, CA (US); Clifford Wayne Mercer, Palo Alto, CA (US); Ulrich Sigmund, Waldkirch (DE)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 11/103,838

(22) Filed: Apr. 11, 2005

(51) Int. Cl. H04N 7/173; A63F 9/24; G06F 19/00; A63F 13/00; G06F 17/00; H04N 7/16

(52) U.S. Cl. 725/133; 725/141; 463/1; 463/40; 463/41; 463/42

(57) ABSTRACT

A video-game system includes a network, a plurality of user devices and a server each coupled to the network. The plurality of user devices are each configured to receive information corresponding to at least one user action for a respective user, to transmit the information corresponding to at least the one user action for the respective user using the network, to receive video-game content using the network and to display the video-game content. The server is configured to receive the information corresponding to at least the one user action for the respective user from one or more of the plurality of user devices and to transmit the video-game content. The server includes a memory storing a video game and a controller configured to execute the video game such that sets of users play the video game substantially simultaneously.

### FIELD OF THE INVENTION

The present invention relates generally to an interactive video-game system, and more specifically to multi-player interactive video-game system.

### BACKGROUND

Video games are a popular form of entertainment. Multi-player games, where two or more individuals play simultaneously in a common simulated environment, are becoming increasingly common, especially as more users are able to interact with one another using networks such as the World Wide Web (WWW), which is also referred to as the Internet. Implementing video games in a networked environment poses several challenges.

In particular, video games, especially those offered high-quality graphics, may produce data streams having a maximum data rate that is a significant fraction of an available data rate communications capacity in a network. The data rate may also vary significantly as a function of time depending on how often a game state for a respective game is modified or updated. This combination of high data rates and time-varying data rates may make cost effective and efficient resource allocation in a networked environment, such as a satellite system, a cable television system or the Internet, challenging. Video-game systems in such network environments may need additional margin, in the form of additional bandwidth overhead as well as hardware and software redundancy, to ensure that performance is not degraded. These systems challenges are compound for multi-player games. There is a need, therefore, for an improved system for implementing video games in networked environments.

### SUMMARY

A video-game system includes a network, a plurality of user devices and a server each coupled to the network. The plurality of user devices are each configured to receive information corresponding to at least one user action for a respective user, to transmit the information corresponding to at least the one user action using the network, to receive video-game content using the network and to display the video-game content. The server is configured to receive information corresponding to user actions from one or more of the plurality of user devices and to transmit the video-game content. The server includes a memory storing a video game and a controller configured to execute the video game such that sets of users play the video game substantially simultaneously.

A respective set of users may include one or more users. Each set of users has a respective game state for the video game. The controller may be configured to execute one or more instances of the video game. Each respective instance of the video game executed by the controller maintains a plurality of the respective game states.

Video-game content may be transmitted from the server to a respective user device in the plurality of user devices using time domain multiplexing.

The memory may further store a plurality of pre-encoded blocks. The pre-encoded blocks may be compressed and may correspond to subsections of a frame of video for the video game. The controller may dynamically generate the video-game content using one or more of the pre-encoded blocks in accordance with a change in the respective game state corresponding to at least the one user action of a respective user in the respective set of users and/or corresponding to an elapsed time since a transmission of previous video-game content. Current video-game content transmitted from the server to the respective user device may include difference information relative to the previous video-game content transmitted from the server to the respective user device.

In some embodiments, a video-game system includes the network, a user device and the server each coupled to the network. The user device is configured to receive information corresponding to at least one user action, to transmit the information corresponding to at least the one user action using the network, to receive video-game content using the network and to display the video-game content. The server is configured to receive the information corresponding to at least the one user action and to transmit the video-game content. The server includes the memory storing the video game and the plurality of pre-encoded blocks. The pre-encoded blocks are compressed and correspond to subsections of the frame of video for the video game. The controller is configured to execute the video game and to dynamically generate the video-game content using one or more of the pre-encoded blocks in accordance with the change in a game state corresponding to at least the one user action and/or the elapsed time since the transmission of the previous video-game content. Current video-game content transmitted from the server to the user device includes difference information relative to the previous video-game content transmitted from the server to the user device.

The pre-encoded blocks may include a macro block. The pre-encoded blocks may be MPEG compatible. The pre-encoded blocks may be encoded using a discrete cosine transformation (DCT). Dynamic generation of the video-game content may include interrelating DCT coefficients corresponding to two or more pre-encoded blocks in real time.

The information corresponding to at least the one user action may be communicated in the network using an out-of-band communications channel.

The server may be in a headend unit in a cable television system. The user device may be a set-top box.

The video-game content may be displayed in real time as updates corresponding to a subset of a full frame of video are received by the user device.

The video-game system may be configured to assign a network address to the user device when order information corresponding to the video game is received.

A data rate corresponding to the video game content transmitted from the server to the user device using the network may be bounded between a pre-determined lower limit and a pre-determined upper limit. The video-game content dynamically generated by the controller may include null blocks to ensure that the data rate is greater than or equal to the pre-determined lower limit.

The video-game system may include one or more additional user devices. Each user device receives and displays video-game content corresponding to a respective user. Two or more users may simultaneously and independently play a single instance of the video game and share at least a subset of the pre-coded blocks. Each of the two or more users may have a corresponding respective game state for the video game.

### BRIEF DESCRIPTION OF THE DRAWINGS

For a better understanding of the invention, reference should be made to the following detailed description taken in conjunction with the accompanying drawings, in which:

FIG. 1 is a block diagram illustrating an existing content distribution system.

FIG. 2 is a block diagram illustrating an embodiment of a cable television system.

FIG. 3 is a block diagram illustrating an embodiment of sub-channels in a cable television system.

FIG. 4 is a block diagram illustrating an embodiment of a cable television system.

FIG. 5 is a block diagram illustrating an embodiment of a video-game system.

FIG. 6A is a block diagram illustrating an embodiment of a video-game system.

FIG. 6B is a block diagram illustrating an embodiment of a video-game system.

FIG. 7 is a block diagram illustrating an embodiment of a video-game system.

FIG. 8 is a block diagram illustrating an embodiment of a video-game system.

FIG. 9 is a block diagram illustrating an embodiment of a set top box.

FIG. 10 is a block diagram illustrating an embodiment of a video-game system.

FIG. 11 is a block diagram illustrating an embodiment of a data stream having a time-varying data rate.

FIG. 12 is a flow diagram illustrating an embodiment of a process in a video-game system.

FIG. 13 is a flow diagram illustrating an embodiment of a process in a video-game system.

FIG. 14 is a flow diagram illustrating an embodiment of a process in a video-game system.

Like reference numerals refer to corresponding parts throughout the drawings.

### DETAILED DESCRIPTION OF EMBODIMENTS

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, and circuits have not been described in detail so as not to unnecessarily obscure aspects of the embodiments.

An improved system for offering interactive video games using networks, such as those in satellite systems, cable television systems (CATV), the Internet, wide area networks, local area networks and/or telephone systems, is described. As described below, the system utilizes efficient digitizing of video-game content corresponding to frames and/or fields of video-game images to reduce a communication bandwidth and thereby increase a number of players or users that may be supported. The term video game includes video games, other forms of computer-implemented recreational application programs, and non-recreational application programs, such as news, weather and/or sports. Players or users refer to a human that participates in the video game.

In particular, the system determines a change in a game state for a video game based on a received respective user action for a respective user or a respective set of users. The system dynamically generates the corresponding video-game content in accordance with the change in the game state using pre-encoded blocks. The system transmits a current video-game content to a user device for display. The current video-game content may correspond to difference information relative to previous video-game content transmitted to the user device. The system allows multiple sets of users to simultaneously and independently play a single executable copy the video game. A respective set of users may include one or more users and each set of users has a respective game state for the video game. In this way, the system improves an efficiency of resource utilization and an overall cost effectiveness.

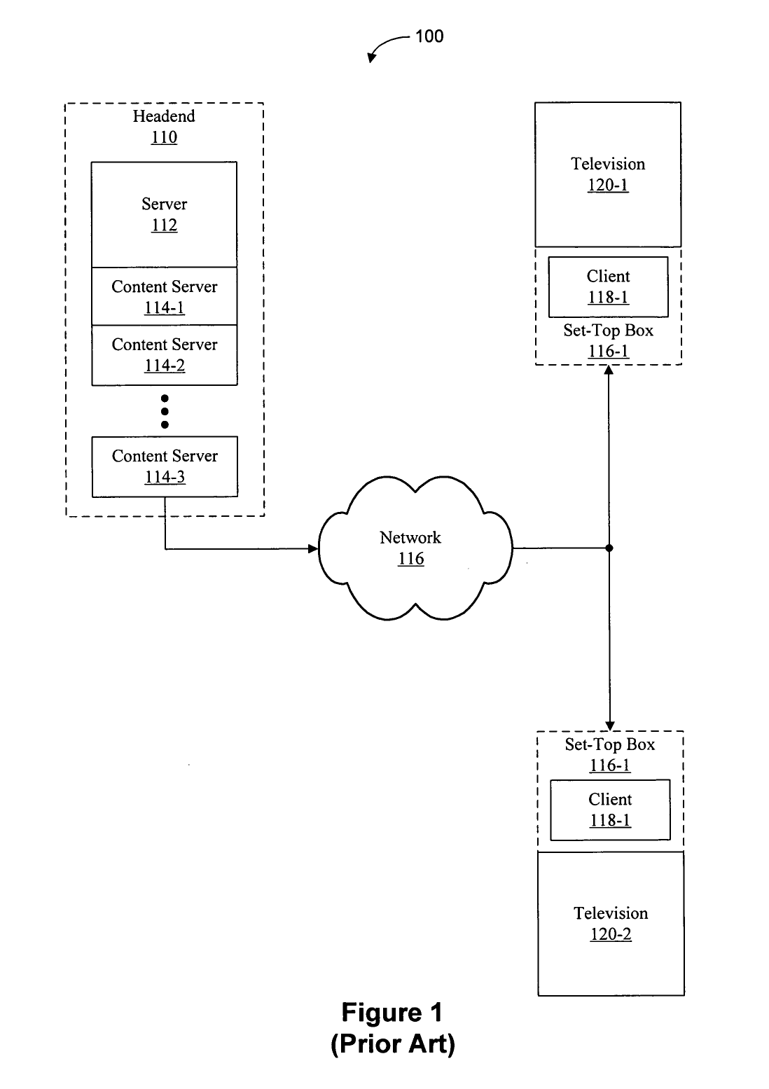

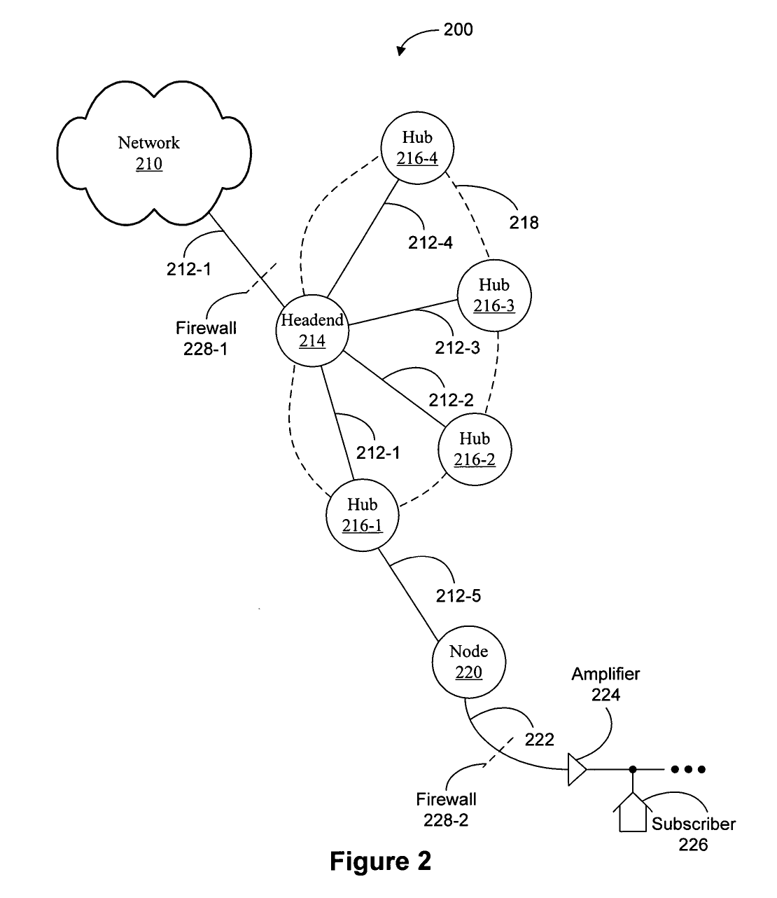

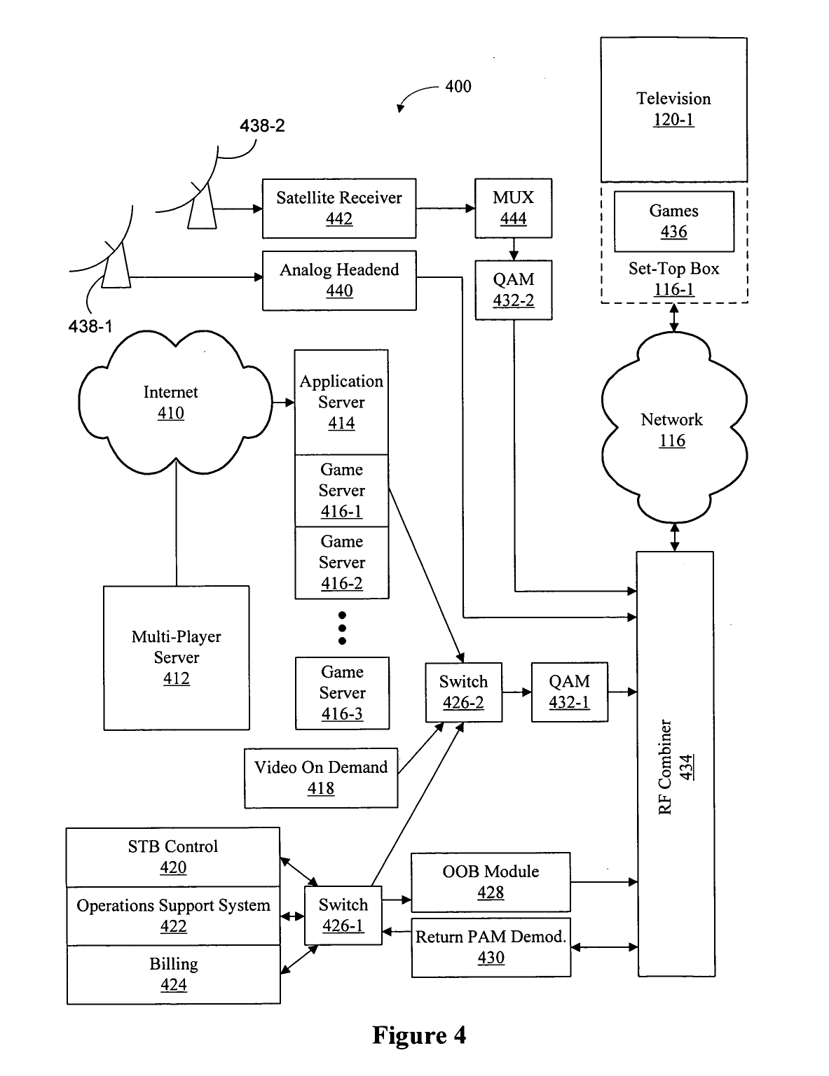

FIG. 1 is a block diagram illustrating an existing content distribution system 100 in a cable television system. A headend 110, discussed further below with reference to FIG. 2, is coupled via a network 116 to a plurality of subscribers or customers. Each subscriber has a set-top box (STB) 116 for receiving content and displaying the content on a television 120. The STB 116 includes a client 118 for running client software. The headend 110 includes a server 112 and a plurality of servers 114 that use an operating system such as Windows, Linux, Unix, Solaris, etc. Applications run on the content servers 114 to provide the content to the subscribers. For example, the content servers 114 may execute instructions corresponding to a browser. A respective browser screen may be scraped to provide a content data stream to a respective subscriber. Thus a separate browser or software stack is implemented for the respective subscriber, i.e., one copy of the content is executed in a respective browser for the respective subscriber. When the content distribution system 100 is utilized to implement multi-player or multi-user video games, a separate instance of the browser and/or video game is executed for each player or user. In contrast, the system described below with reference to FIG. 4 may have many-to-one correspondence between respective users and an executed copy of the content.

To describe the improved video-game system and how it is integrated into systems such as cable television systems, an overview of cable television systems architecture is now discussed. FIG. 2 illustrates an embodiment of a cable television system 200. A network 210, which is coupled to distribution and systems management devices (not shown), is coupled via a fiber optical communication link 212, such as one or more fiber optic cables, to a headend 214. The cable television system 200 may include additional headends. Each headend provides service to 1000 to 500,000 subscribers. The headend 214 is coupled to a plurality of hubs 216 via the fiber optical communications link 212. The headend 214 and the hubs 216 may be optionally linked with a fiber optic communications ring 218, which may include one or more fiber optic cables. The fiber optic communications ring 218 may utilize a dense wavelength division multiplexing communications protocol.

A respective hub, such as hub 216-1, is coupled to one or more service groups or nodes, such as node 220, via the optical communication link 212. The node 220 provides service to 200 to 2000 subscribers in a neighborhood. Each node, such as the node 220, is coupled to one or more subscribers, such as subscriber 226, via a coaxial cable 222 and one or more amplifiers, such as amplifier 224. The cable television system 200 may also include one or more firewalls 228 to prevent an unauthorized program or content, such as a virus, from entering the system and infecting one or more computers in the hubs 216 and/or the headend 214.

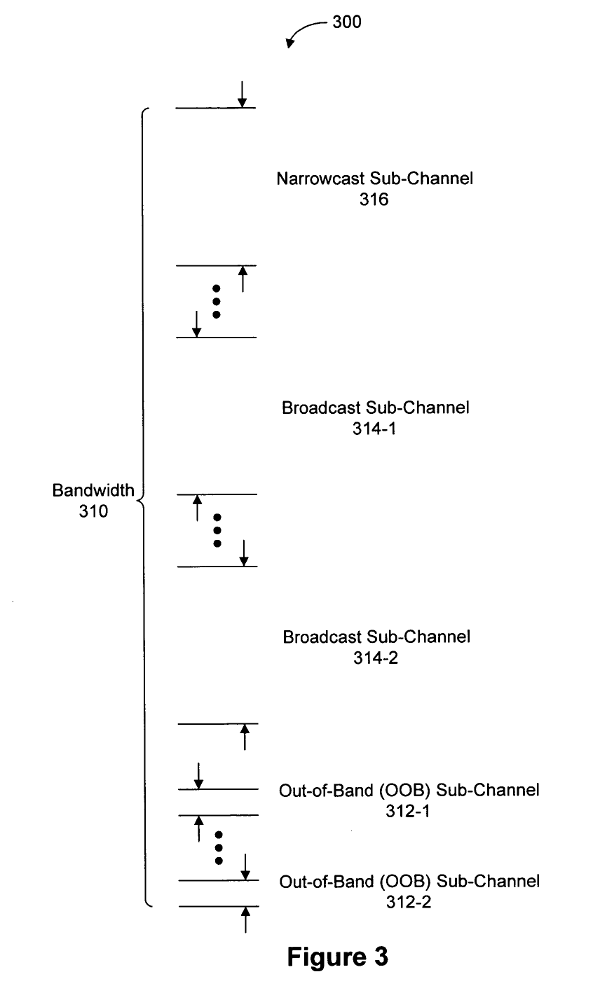

Cable television systems, such as the cable television system 200, support communications of analog and digital signals using time division multiplexing and frequency division multiplexing. The latter is shown in FIG. 3, which illustrates an embodiment 300 of sub-channels in a cable television system. The cable television system may support a bandwidth 310. In an exemplary embodiment, the bandwidth may be 800 MHz. The bandwidth 310 is subdivided into a plurality of narrowcast sub-channels, such as narrow cast sub-channel 316, two or more broadcast sub-channels 314, and two or more out-of-band (OOB) sub-channels 312. The plurality of narrowcast sub-channels may be used for digital services such as video on demand (VOD) and/or video games. Signals in one or more of the OOB sub-channels 312 may utilize a Data Over Cable Service Interface Specification (DOCSIS) or cable modem format, a Digital Audio Video Interoperability Council (DAVIC) format and/or a proprietary format standard such as that offered by Motorola.

In an exemplary embodiment, if a 256-level quadrature amplitude modulation (QAM) is used, each narrowcast sub-channel, such as narrowcast sub-channel 316, having a bandwidth of approximately 6 MHz, corresponds to approximately 38 Mbps of digital data or some 10 digital channels each having a data rate of 3.75 Mbps. For a video game that utilizes between 1 and 4 Mbps, the narrow cast sub-channel 316 would correspond to 10 to 30 video game data streams.

The broadcast sub-channels 314 each correspond to one analog television channel. In an exemplary embodiment, each of the broadcast sub-channels has a bandwidth of approximately 6 MHz and analog television signals are transmitted in an NTSC format. Other embodiments, however, may utilize different formats such as PAL or SECAM. The OOB sub-channels 312 each may correspond to a bit or data rate of approximately 1 Mbps.

Attention is now given to the improved video-game system. FIG. 4 is a block diagram illustrating an embodiment of a cable television system 400. Several content data streams may be transmitted to the respective subscriber and the respective subscriber may, in turn, order services or transmit user actions in a video game. Satellite signals, such as analog television signals, may be received using satellite antennas 438. Analog signals may be processed in analog headened 440, coupled to radio frequency (RF) combiner 434 and transmitted to STB 116-1 via the network 116. In addition, signals may be processed in satellite receiver 442, coupled to multiplexer (MUX) 444, converted to a digital format using QAM 432, coupled to the radio frequency (RF) combiner 434 and transmitted to STB 116-1 via the network 116. Video on demand (VOD) server 418 may provide signals corresponding to an ordered movie to switch 426-2, which couples the signals to QAM 432-1 for conversion into the digital format. These digital signals are coupled to the radio frequency (RF) combiner 434 and transmitted to STB 116-1 via the network 116. The STB 116-1 may display one or more signals, include those corresponding to video-game content discussed below, on television 120-1. While FIG. 4 illustrates one subscriber STB 116-1 and television 120-1, in other embodiments there may be additional subscribers, each having one or more STBs and/or televisions.

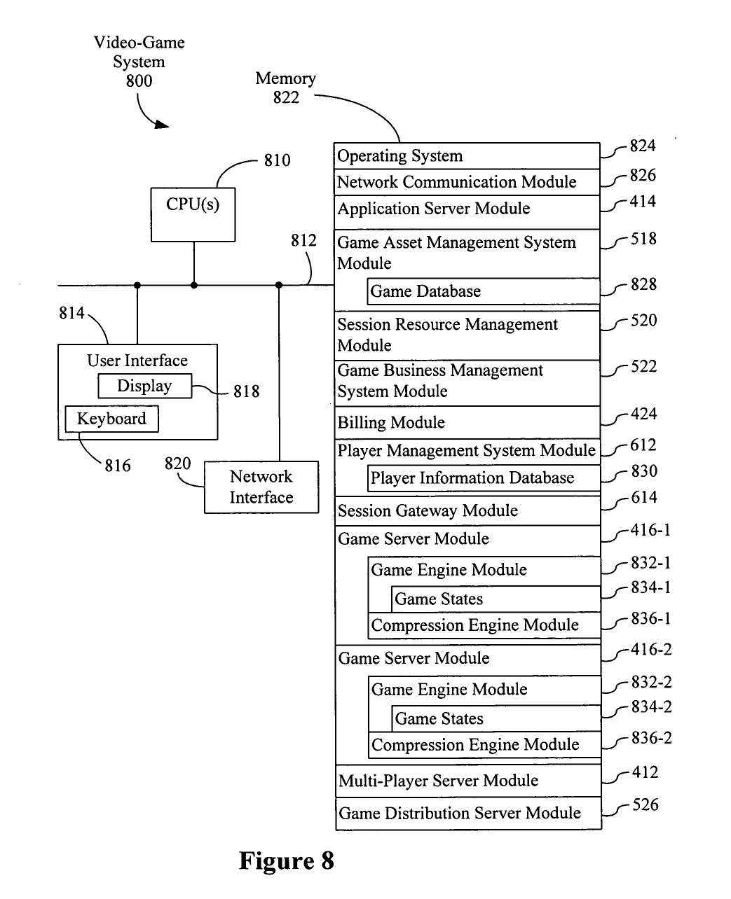

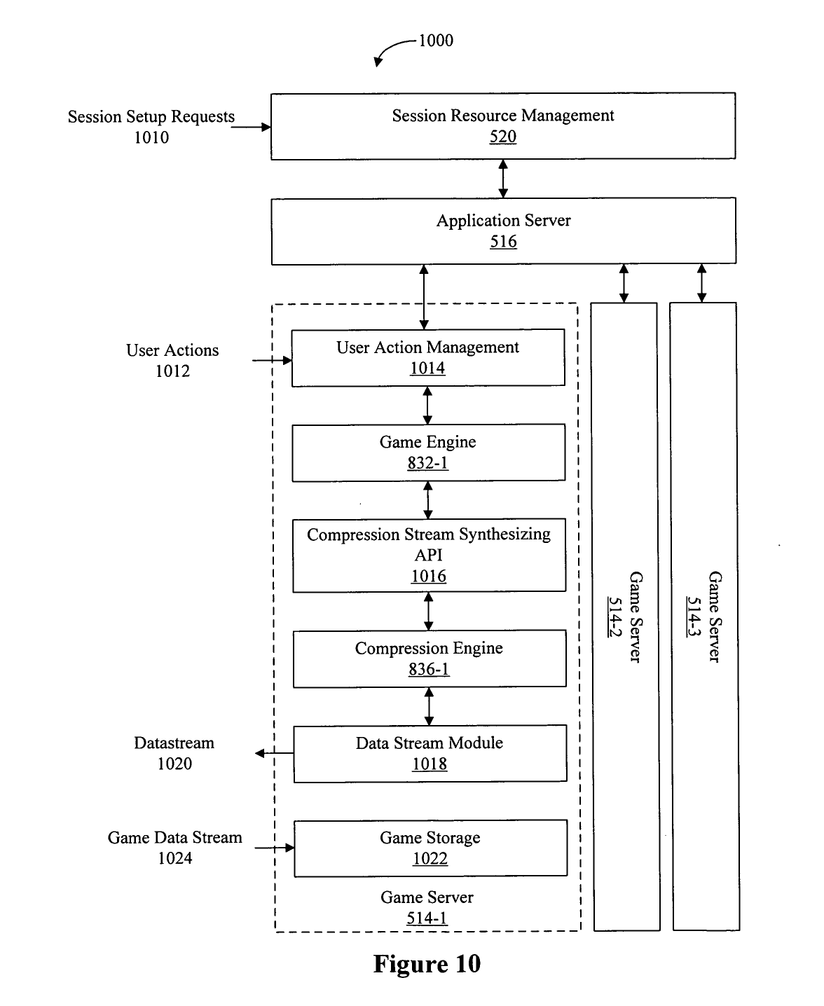

The cable television system 400 may also include an application server 414 and a plurality of games servers 416. The application server 414 and a plurality of games servers 416 may be located in a headend, such as the headend 214 (FIG. 2). While a single instance or grouping of the application server 4141 and the plurality of game servers 416 are illustrated in FIG. 4, other embodiments may include additional instances in one or more headends. The application server 414 and one or more of the game servers 416 may provide video-game content corresponding to one or more video games. The application server 414 may access and/or log game-related information in a database. The application server 414 may also be used for reporting and pricing. One or more game engines 832 (FIGS. 8 and 10) in the game servers 416 is designed to dynamically generate video-game content using pre-encoded blocks. In an exemplary embodiment, the game servers 416 (FIGS. 8 and 10) use MPEG encoding.

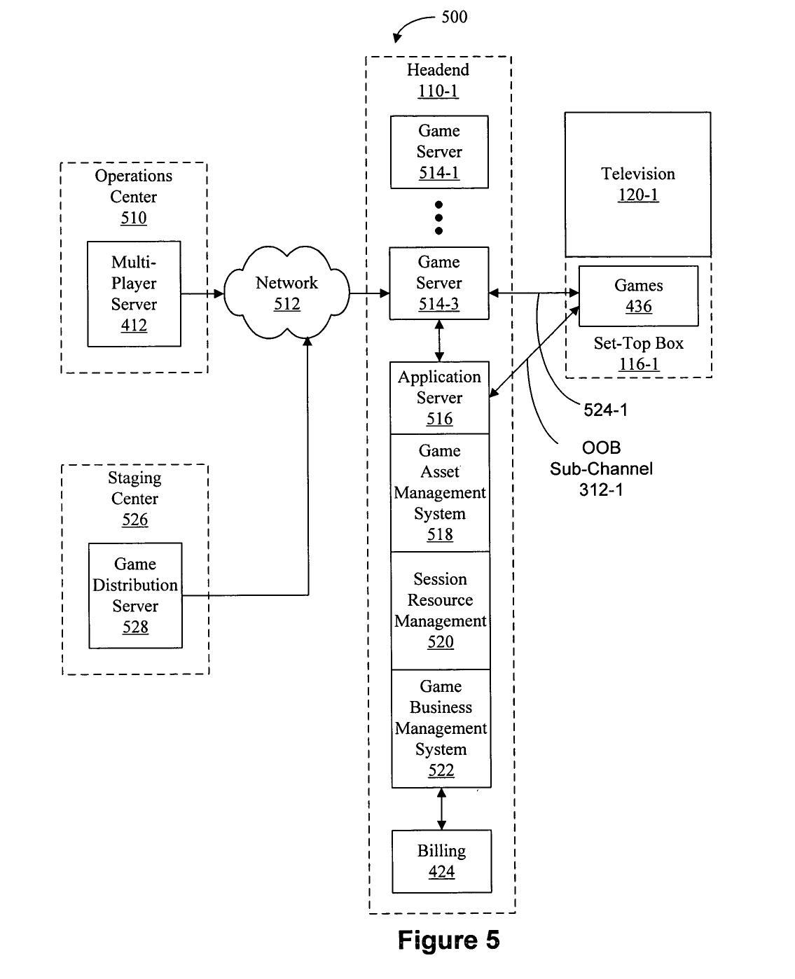

The video-game content is coupled to the switch 426-2, converted to the digital format in the QAM 432-1. These digital signals are coupled to the radio frequency (RF) combiner 434 and transmitted to STB 116-1 via the network 116. The Applications server 414 may also access, via Internet 410, persistent player or user data in a database stored in multi-player server 412. The applications server 4141 and the plurality of game servers 416 are further described below with reference to FIG. 5.

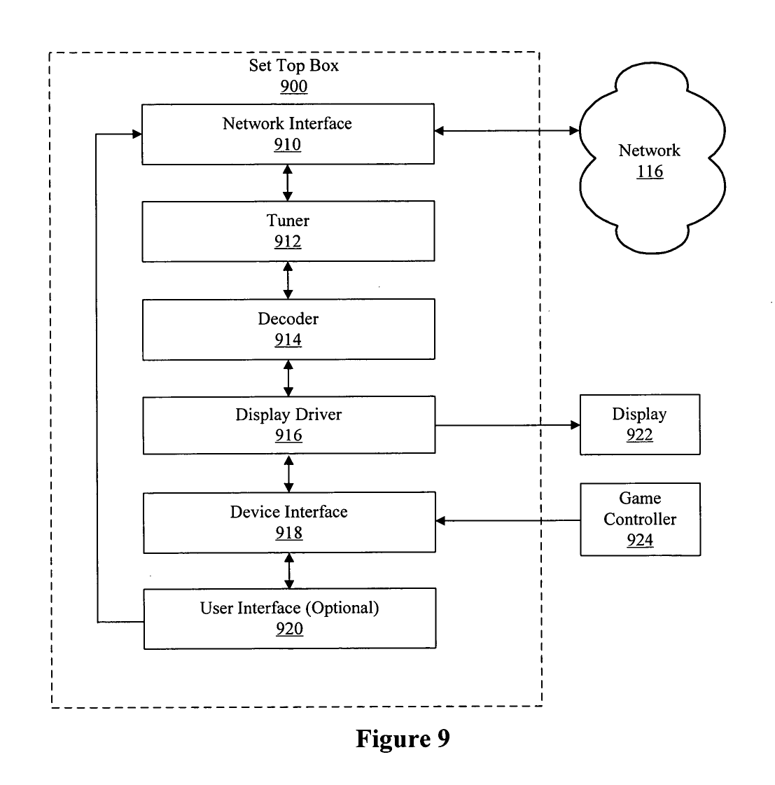

The STB 116-1 may include a client application, such as games 436, that receives information corresponding to one or more user actions and transmits the information to one or more of the game servers 416. The games application 436 may also store video-game content prior to updating a frame of video on the television 120-1. The STB 116-1 is described further below with reference to FIG. 9.

The cable television system 400 may also include STB control 420, operations support system 422 and billing system 424. The STB control 420 may process one or more user actions, such as those associated with a respective video game, that are received using an OOB sub-channel, such as OOB sub-channel 312-1 (FIG. 3), using return pulse amplitude (PAM) demodulator 430 and switch 426-1. The operations support system 422 may processes a subscribers order for a respective service, such as the respective video game, and update the billing system 424. The STB control 420, the operations support system 422 and/or the billing system 424 may also communicate with the subscriber using the OOB sub-channel via the switch 426-1 and the OOB module 428, which converts signals to a format suitable for the OOB sub-channel. Alternatively, the operations support system 422 and/or the billing system 424 may communicate with the subscriber via another communication slink such as that provided by a telephone system.

The various signals transmitted and received in the cable television system 400 may be communicated using packet-based data streams. In an exemplary embodiment, some of the packets may utilize an Internet protocol. In some embodiments, networks, such as the network 116, and coupling between components in the cable television system 400 may include one or more instances of a wireless area network, a local area network, a transmission line such as a coaxial cable, a land line and/or an optical fiber. Some signals may be communicated using plain-old-telephone service (POTS) and/or digital telephone networks such as an Integrated Services Digital Network (ISDN). Wireless communication may include cellular telephone networks using an Advanced Mobile Phone System (AMPS), Global System for Mobile Communication (GSM), Code Division Multiple Access (CDMA) and/or Time Division Multiple Access (TDMA), as well as networks using an IEEE 802.11 communications protocol, also known as WiFi, and/or a Bluetooth communications protocol.

While FIG. 4 illustrates a cable television systems, the system and methods described may be implemented in a satellite-based system, the Internet, a telephone system and/or a terrestrial television broadcast system. The cable television system 400 may include additional elements and/or remove one or more elements. In addition, two or more elements may be combined into a single element and/or a position of one or more elements in the cable television system 400 may be changed.

FIG. 5 is a block diagram illustrating an embodiment of a video-game system 500. Headend 110-1 includes a plurality of game servers 514, an applications server 516, a game asset management system 518, a session resource management (SRM) 520, game business management system 522 and the billing system 424. Communication in the headend 110-1 may be via one or more fiber optic cables and/or gigabit ethernet connections. The headend 110-1 is coupled to an operations center 510 and a staging center 526 via a network 512. Communications on the network 512 may be encrypted. In some embodiments, the network 512 may be a virtual private network. The operations center 510 includes the multi-player server 412. The distribution or staging center 526 includes a game distribution server 528.

The headend 110-1 is also coupled to one or more users of one or more video games. Each user has at least one television 120-1 and STB 116-1. The STB 116-1 may include the client application such as the games 436. Bi-directional communication link 524-1 may occur between one or more game servers 514 and the STB 116-1. A bandwidth or data rate in each direction may, however, be asymmetric. For example, a higher data rate may be available from the headend 110-1 to the STB 116-1. A data stream from the STB 116-1 to one of the game servers 514, such as the game server 514-3, may contain information corresponding to one or more user actions in one or more video games. The STB 116-1 may also have bi-directional communication with the application server 516 using OOB sub-channel 312-1.

The application server 516 manages video game distribution (loading of video games), billing and business infrastructure (integration). After testing of a new video game is completed, the game distribution server 528 alters one or more headends, such as the headend 110-1, that the new video game is ready for distribution. The game asset management system 518 fetches and distributes the new video game. The game asset management system 518 stores related pricing information in the game business management system 522 and content corresponding to the new video game, such as one or more pre-encoded blocks and executable video game instructions in the game servers 514. The game asset management system 518 supports an Asset Distribution Interface, a format for movies that has been extended to include video games. The game asset management system 518 may also include meta data for the video games, including a publisher of the respective video game, a description of the respective video game, a name of the respective video game, one or more performance characteristics of the respective video game such as a bit or data rate.

The game business management system 522 handles pricing, terms of use (such as pay per day, unlimited usage) and possible bundling of one or more video games for rental as a package. The SRM 520 allocates resources for use in communication with a respective user and handles initial processes in response to the respective video game being ordered. The SRM 520 may support bit or data rates other than those corresponding to VOD.

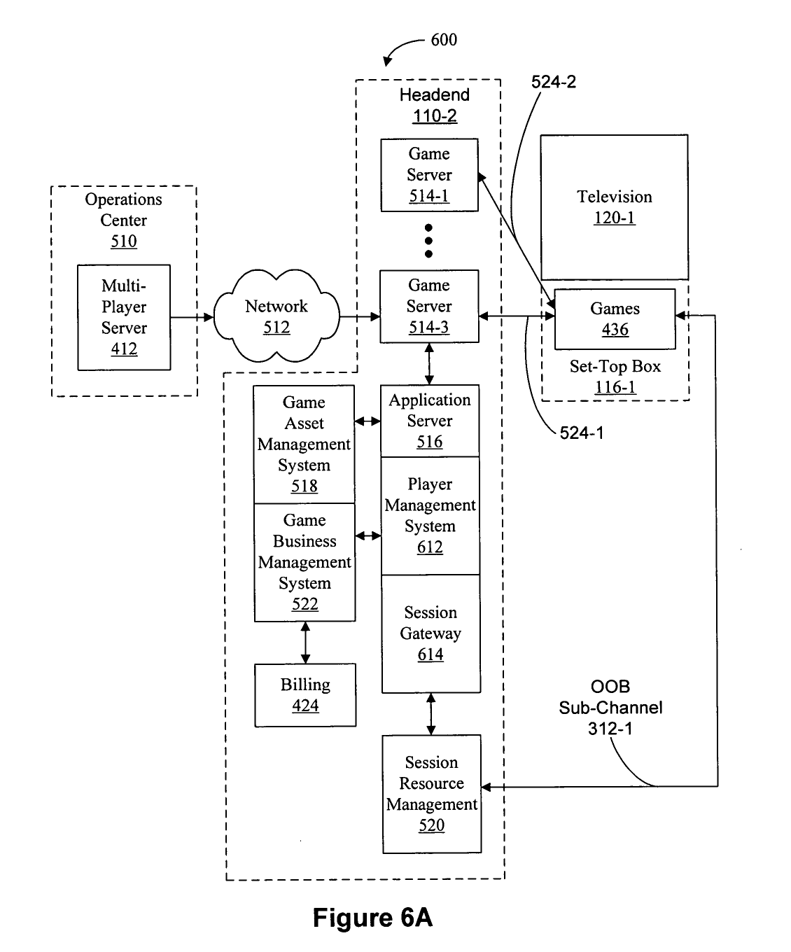

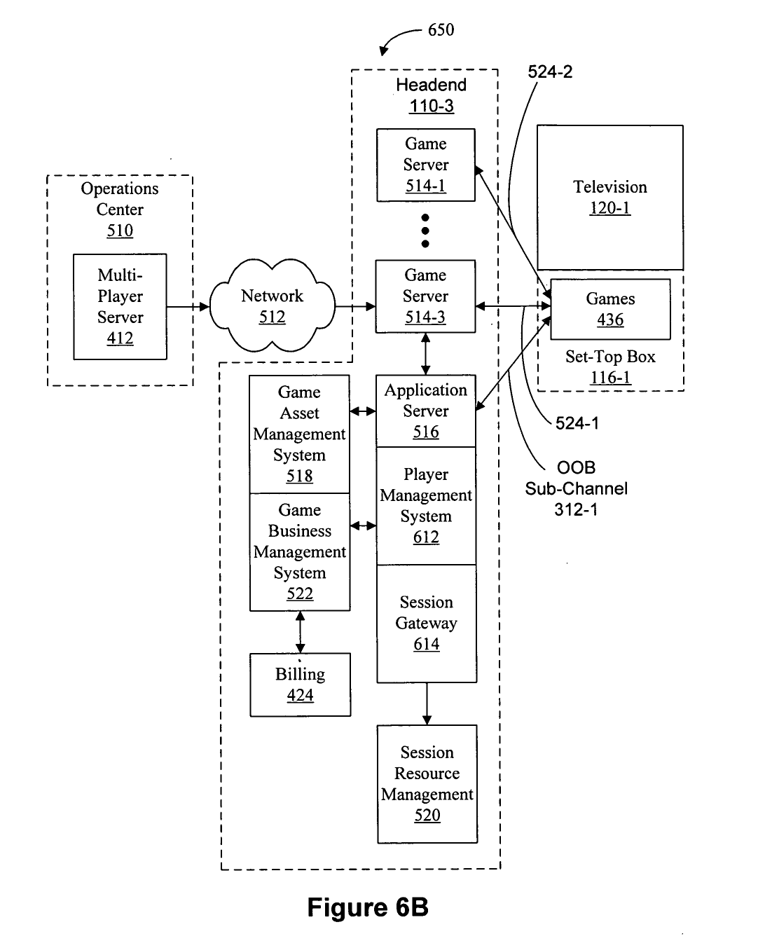

When the respective user orders the respective video game, the cable television system, via the operations support system 422 (FIG. 4), establishes communication between the STB 116-1 and the headend 110-1, an in particular to the SRM 520. Routing of communications, such as data packets, may use Internet protocol addresses. In some embodiments, there may be a fixed address mapping, such as provided by a look-up table. In other embodiments, dynamically assigned network address may be used. These may be provided by session gateway 614 (FIG. 6A).

During the ordering process, additional information may be requested from the respective user prior to starting the respective video game, such as authentication, billing, payment and security data. In addition, persistent user information, such as user meta data in the multi-player server 412, may be accessed by the application server 516. The player meta data may include saved video game states, rankings and/or high score.

The application server 516 may then assign the respective user to a respective game server, such as the game server 514-3, which in turn, assigns the respective user to a respective game engine, such as the game engine 832 (FIG. 8) in the respective game server 514-3. The respective user may be assigned the respective game server 514-3 based on the available capacity of the game servers 514 and/or on the availability of other video game users or participants. For example, there may not be enough users currently available for a multi-player video game. If not, the user may be given the option to wait until there are enough players or to select a different video game to play. The assigned respective game server 514-3 may also be in accordance with at least a portion of the user meta data. For example, the respective user may be assigned to the respective game server 514-3 and/or a respective instance of the respective video game based on his or her skill level. The respective user may be identified based on a network address of his or her STB 116-1 or by a numerical identifier entered by the respective user when ordering the respective video game. Alternatively, the respective user may specify the skill level he or she would like to compete at, such as beginner, intermediate, advanced or expert.

One or more user actions in the respective video game may be communicated from the STB 116-1 to the respective game server 514-3 using a variety of communication paths and/or formats. The user actions may be communicated directly from the STB 116-1 to the respective game server 514-3 using the bi-directional communication link 524-1. Alternatively, one or more user actions may be communicated using the OOB sub-channel 312-1. The user actions may be communicated using a General Stream Control Protocol (GSCP) or a modified GSCP. GSCP is a format for communicating key strokes from the STB 116-1 to respective game server 514-3. The STB 116-1 may also support an extended version of a VOD protocol called Lightweight Stream Control Protocol (LSCP). LSCP supports additional key events in addition to arrow or navigation keys, select and okay.

In some embodiments, the respective user may also be able to audio chat with one or more additional users of the same video game or another video game using the OOB sub-channel 312-1 or a back channel, such as provided by a telephone system or a wireless communication link. In some embodiments, the audio chat may utilize a DOCSIS format.

The game servers 514 provide video-game content to one or more users using a combination of static or shared game assets and dynamic processing. The game servers 514 include a plurality of pre-encoded blocks. In an exemplary embodiment, the pre-encoded blocks are MPEG macro blocks. Each block corresponds to a 16×16 pixel element. For standard definition NTSC video, there are 640 horizontal lines and 480 vertical pixels. Therefore, a full frame of video corresponds to 30 horizontal slices each containing 40 macro blocks. The pre-encoded blocks may be compressed using a discrete cosine transformation (DCT). The pre-encoded blocks may be stored in a chrominance/luminance or YUV format. Each pre-coded block may be compressed individually. The pre-coded blocks, however, are not compressed independently of neighboring macro blocks.

In the dynamic portion of the processing, the game servers 514 dynamically stitch or interrelate the pre-encoded blocks in accordance with changes in a game state based on one or more user actions. The game state for a respective set of users represents the current state of the game, and provides sufficient information for the game server to respond to user actions that impact on the game state and to generate video-game content that advances the video game from the viewpoint of the user or users in a manner consistent both with the prior game state and the most recent user actions. In embodiments where the pre-encoded blocks are MPEG compatible macro blocks, corresponding DCT coefficients are interrelated or interleaved in real time as the data stream is generated and transmitted to the STB 116-1. Current video-game content transmitted includes difference information with respect to previous video-game content, such as at least a subset of a frame of video, that was transmitted to and display by the STB 116-1. In some embodiments, motion compensation may be utilized based on movement of one or more objects or pre-encoded blocks in a frame of video. In some embodiments, one or more of the game servers 514 may also blend additional graphics into the transmitted video-game content in real time. The video-game content may also include audio. The audio information may also include pre-compressed blocks. In an exemplary embodiment, a Dolby audio encoding format, such as Dolby Audio Coding-3 (AC3), is used.

The video-game content may be transmitted to the respective user using time domain multiplexing where the video-game content is transmitted in a series of time slices. In some embodiments, the video-game content transmitted to one or more users may be substantially the same. In other embodiments, two or more users may receive different video-game content. The video-game content may be transmitted to one or more users using one or more sub-channels.

While FIG. 5 illustrates one headend 110-1, in other embodiments there may be one or more additional headends. The video-game system 500 may include additional elements, remove one or more elements, two or more elements may be combined into a single element and/or a position of one or more elements in the video-game system 500 may be changed. In addition, communications between two or more of the elements may be added or removed.

As noted above, additional embodiments may rearrange the position of one or more elements in the video-game system 500. FIGS. 6A and 6B are block diagrams illustrating such embodiments of a video-game system 600 and a video-game system 650. In addition, communication between the elements is also modified, such as additional bi-directional communication link 524-2, the coupling of the application server 516 and the game asset management system 518 and the coupling of the player management system 612 and the game business management system 522 in FIGS. 6A and 6B, and the coupling of the OOB sub-channel 312-1 to the session resource management 520 in FIG. 6A.

The video-game system described above, such as embodiments 500, 600 and 650, may offer efficient resource allocation and overall cost effectiveness especially as the approach is scaled to multiple users. For example, in some embodiments, a plurality of sets of users may be able to play a single instance or copy of the respective video game substantially simultaneously and independently. Each respective set of users may include one or more users sharing a respective game state. A controller for the respective video game, therefore, is configured or configurable to maintain a plurality of the respective game states. In this way, the video-game system may support multiple parallel games using the single instance or copy of the respective video game. In an exemplary embodiment, 100 or more users arranged in multiple sets of users may play a single copy of a video game. This is in contrast with existing multi-user or multi-player video games, where multiple users compete in a shared virtual environment by communicating between multiple copies of the video game that are running simultaneously.

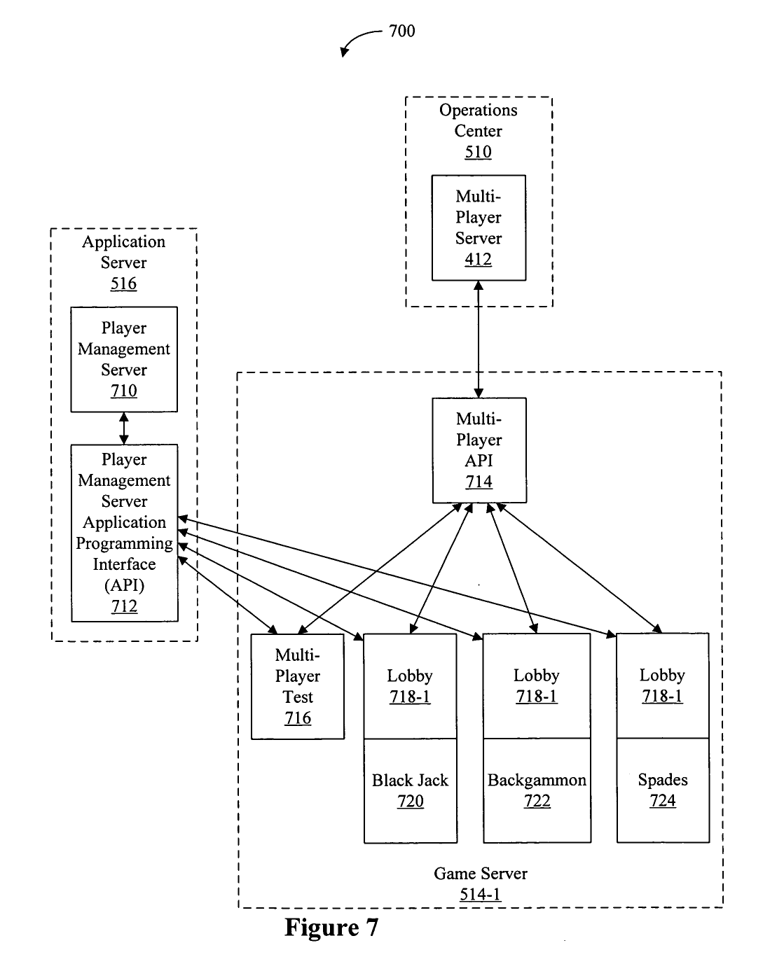

FIG. 7 is a block diagram illustrating an embodiment of a video-game system 700 for multi-user video games. Game server 514-1 is coupled to the operations center 510 and the application server 516. The operations center 510 includes the multi-player server 412, which may store persistent user data such as user meta data. The applications server 516 includes a player management server 710 and player management server application programming interface (API) 712. The game server 514-1 includes multi-player API 714, multi-player test 716 and multiple lobbies 718 for multiple video games such as Black Jack 720, Backgammon 722 and Spades 724. Each lobby, such as lobby 718-1, may include an application interface that, at least in part, enables matching of users on the network 116 (FIG. 4) with other users desiring to play a respective video game. In some embodiments, the lobbies 718 include a number of so-called tables where various video games may be played. In these embodiments, the lobbies 718 are an application interface that, at least in part, enables users to see (via a graphical user interface implemented by the use's set top boxes 116) the tables available and to join a respective table to play a video game with one or more additional users.

In FIG. 7, one or more users select the respective video game and are coupled to the corresponding lobby, such as the lobby 718-1, by the player management server 710 to match up with other users who are interested in playing the respective video game. Some video games may have options or attributes or characteristics that make the table or the user more or less desirable for a respective user to select. Such attributes may include a ranking of other users, a skill level indicated by an attribute other than the ranking, a minimum bet (for video games that include gambling, such as poker games). Some or all of these attributes may be stored in Multi-Player Server 412. Once users have been matched together in the corresponding lobby, they transition to actual video game play.

FIG. 8 is a block diagram illustrating an embodiment of a video-game system 800. The video-game system 800 may include at least one data processor, video processor and/or central processing unit (CPU) 810, one or more optional user interfaces 814, a communications or network interface 820 for communicating with other computers, servers and/or one or more STBs (such as the STB 116-1 in FIG. 4), memory 822 and one or more signal lines 812 for coupling these components to one another. The user interface 814 may have one or more keyboards 816 and/or displays 818. The one or more signal lines 812 may constitute one or more communications busses.

Memory 822 may include high-speed random access memory and/or non-volatile memory, including ROM, RAM, EPROM, EEPROM, one or more flash disc drives, one or more optical disc drives and/or one or more magnetic disk storage devices. Memory 822 may store an operating system 824, such as LINUX, UNIX or WINDOWS, that includes procedures (or a set of instructions) for handling basic system services and for performing hardware dependent tasks. Memory 822 may also store communication procedures (or a set of instructions) in a network communication module 826. The communication procedures are used for communicating with one or more users using STBs, such as the STB 116-1 (FIG. 4), and with other servers and computers in the video-game system 800.

Memory 822 may also include the following elements, or a subset or superset of such elements, including the applications server module 414 (or a set of instructions), the game asset management system module 518 (or a set of instructions), the session resource management module 520 (or a set of instructions), the game business management system module 522 (or a set of instructions), the billing system module 424 (or a set of instructions), the player management system module 612 (or a set of instructions), the session gateway module 614 (or a set of instructions), one or more game server modules 416 (or sets of instructions), the multi-player server module 412 (or a set of instructions) and the game distribution server 526 (or a set of instructions). The game asset management system module 518 may include a game database 828 including pre-encoded blocks and executable code corresponding to one or more video games. The player management system module 612 may include a player information database 830 including information such as user's name, account information, transaction information, preferences for customizing display of video games on the STB 116-1 (FIG. 4), high scores for the video games played, rankings and other skill level information for video games played, a persistent saved game state for video games that have been paused and may resume later. Each instance of the game server module 416 may include one or more game engine modules 832 and one or more compression engine modules 836. The game engine modules 832 may also include games states 834 corresponding to one or more sets of users playing one or more video games.

Although FIG. 8 shows the video-game system 800 as a number of discrete items, FIG. 8 is intended more as a functional description of the various features which may be present in a video-game system rather than as a structural schematic of the embodiments described herein. In practice, and as recognized by those of ordinary skill in the art, the functions of the video-game system 800 may be distributed over a large number of servers or computers, with various groups of the servers performing particular subsets of those functions. Items shown separately in FIG. 8 could be combined and some items could be separated. For example, some items shown separately in FIG. 8 could be implemented on single servers and single items could be implemented by one or more servers. The actual number of servers in a video-game system and how features, such as the game server modules 416 and the game engine modules 832, are allocated among them will vary from one implementation to another, and may depend in part on the amount of information stored by the system and/or the amount data traffic that the system must handle during peak usage periods as well as during average usage periods. The game server 416 is described further below with reference to FIG. 10.

FIG. 9 is a block diagram illustrating an embodiment of a set-top box (STB) 900, such as the STB 116-1 (FIG. 4). The STB 900 transmits order information and information corresponding to user actions, and receives video-game content using the network 116. Received signals are processed using network interface 910 to remove headers and other information in the data stream containing the video-game content. The resulting signals are processed in tuner 912, to select frequencies corresponding to one or more sub-channels, and in decoder 914. In an exemplary embodiment, the decoder 914 is an MPEG2 decoder. In other embodiments, the decoder 914 may be an MPEG compatible decoder or a decoder for another video-compression standard. The video-game content output from the decoder 914 is converted to an appropriate format for driving display 922 using display driver 916. User actions input to the game controller 924 are received by device interface 918 and forwarded to the network interface 910 for transmission. The STB 900 may optionally include a user interface 920, such as a keyboard, buttons, and/or a liquid crystal or other display.

The game controller 924 may be a dedicated video-game console, such as those provided by Sony Playstation®, Nintendo®, Sega® and Microsoft Xbox® or a personal computer. The game controller 924 may receive information corresponding to one or more user actions from a game pad, keyboard, joystick, microphone, mouse, one or more remote controls, one or more additional game controllers or other user interface such as one including voice recognition technology. The display 922 may be a cathode ray tube or a liquid crystal display in a television, a computer or a portable device, such as a video game controller 924 or a cellular telephone.

The STB 900 may have an embedded operating system such as Linux, OS9 or Windows, or a real-time operating system (e.g., VxWorks by Wind River Systems, Inc.) suitable for use on industrial or commercial devices.

In some embodiments, the STB 900 may perform a smoothing operation on the received video-game content prior to displaying the video-game content. In some embodiments, received video-game content is displayed on the display 922 in real time as it is received. In other embodiments, the STB 900 stores the received video-game content until a full frame of video is received. The full frame of video is then displayed on the display 922.

FIG. 10 is a block diagram illustrating an embodiment of a video-game system 1000. The session resource management 520 may receive session setup requests 1010 and route them, including appropriate network addressing if needed, to the application server 516. The video-game system 1000 also includes a plurality of the game servers 514. The game servers 514 are tied together to report a respective loading condition of each game server, such as the game server 514-1. Loading information (e.g., one or more activity metrics for each game server, such as a metric based on the number of active video game states in each game server) is passed to the application server 516, which may re-direct one or more users to a different game server 514 for processing of video games. In this way, the video-game system 1000 may balance a loading of the game servers 514.

The video-game system 1000, and one or more of the game servers 514, may support one or more video games, such as chess, checkers and/or cards, running simultaneously. In addition, as described previously, a respective video game may be run such that a plurality of sets of users may play the respective video game independently and substantially simultaneously.

Each game server, such as the game server 514-1, includes user action management 1014 to process information corresponding to one or more user actions 1012 such that a corresponding game state may be updated, one or more game engines 832, a compression stream synthesizing API 1016 to provide an interface for video and/or audio data streams, a compression engine 836 (such as MPEG2) and a data stream module 1018 to output a data stream 1020 (such as data packets) to one or more STBs. In addition, each of the game servers 514 may include game storage 1022 to receive one or more video game data streams 1024. The game storage 1022 may store the pre-coded blocks and the video-game executable instructions for one or more video games. The game storage 1022 may also store one or more game states corresponding to one or more user sets for one or more video games.

In some embodiments, one or more of the game servers 514 may provide an equal amount of processor time to a respective instance of the respective video game and/or a respective user set of the respective video game. In other embodiments, the respective instance of the respective video game and/or a respective user set of the respective video game may be provided with no processor time if the corresponding respective game state is unchanged. In the event that no user action 1012 is received for the respective user, one or more of the game servers 514 may provide video-game content to the respective STB, such as the STB 116-1 (FIG. 4), after a pre-defined time interval has elapsed. The game servers 514 may also support interrupt-driven processing based on information corresponding to the user actions 1012 that is received.

The game servers 514 may run a browser application, such as Windows Explorer, Netscape Navigator or Mozilla from FireFox, to execute instructions corresponding to a respective video game. The browser application, however, may be configured to not render the video-game content in the game servers 514. Rendering the video-game content is unnecessary, since the content is not displayed by the game servers, and avoiding such rendering enables each game server to maintain many more game states than would otherwise be possible.

The game server 514 may have one or multiple processors. Video games may be implemented in a parallel by multiple processors. Games may also be implemented in a multi-threaded operating system.

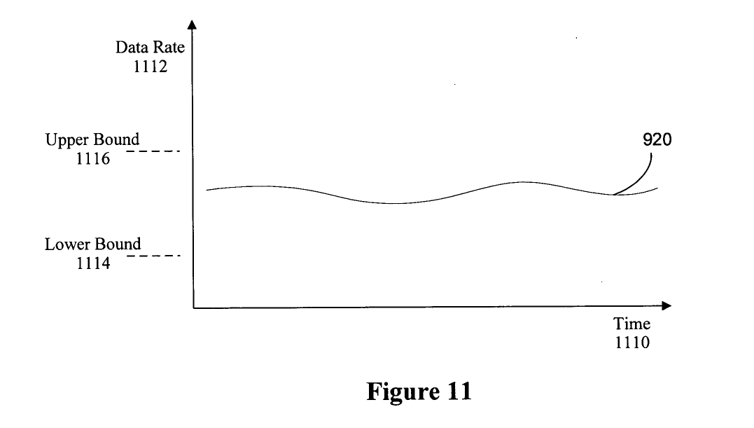

The data stream 1020 transmitted by one or more of the game servers 514 to the respective user or users may have a bit or data rate that is bounded between a pre-determined lower limit and a pre-determined upper limit. FIG. 11 is a block diagram illustrating an embodiment of the data stream 1020 having a data rate 1112 as a function of time 1110. While the data rate 1112 is time varying, it is maintained between a lower bound 1114 and an upper bound 1116. Such a bounded data rate 1112 may allow more efficient allocation of resources in a video-game system, such as the video-game system 400 (FIG. 4), and an overall cost effectiveness. In particular, the bounded data rate 1112 may prevent a respective data stream for one or more users from temporarily utilizing a significant fraction of the available resources in the system or a network, such as the network 116 (FIG. 4). In embodiments where the pre-encoded blocks and the video-game content are encoded using an MPEG compatible compression, such as MPEG2, intra-coded frames or I frames, which represent a full independent video frame and correspond to a larger data rate 1112, are not transmitted. The data stream may include separate intra-coded macro blocks in Predictive coded frames or P-frames during certain time intervals. This may assist in keeping the data rate 1112 bounded. To ensure compatibility with MPEG standards in these embodiments, a null frame or transport packet, such as a predicted but not coded macro block, may be transmitted instead of the I frame. A null frame or transport packet may also be added to the video-game content to ensure that the data rate 1112 is greater than or equal to the lower bound 1114. In exemplary embodiments, the upper bound 1116 may be 0.03, 0.1, 0.16, 0.25 or 0.33 of a corresponding MPEG data stream containing I frames. The data stream 1020 may include 30 P frames per second. In some embodiments, the conservation of transmission bandwidth achieved through the use of these techniques may enable a 20-fold increase in a number of users or user sets per game engine 832 (FIG. 10) with respect to existing video-game systems.

In embodiments where only P frames are transmitted during certain time intervals, there may be challenges associated with error propagation since some information is lost during MPEG compression and some is not repeated for each P frame, and may be lost during transmission due to network or communication failures. This challenge may be addressed by transmitting a full frame of video, such as an I frame, as a form of error correction by resetting the displayed frame of video to a known ‘good’ condition. Such a full frame of video may be transmitted periodically or after a pre-defined time interval has elapsed. Alternately, individual stripes of intra-coded macro blocks may be transmitted periodically, so that the entire frame is repainted with fresh video data at a predefined rate, or at a rate no less than a predefined rate (e.g., at least once per second).

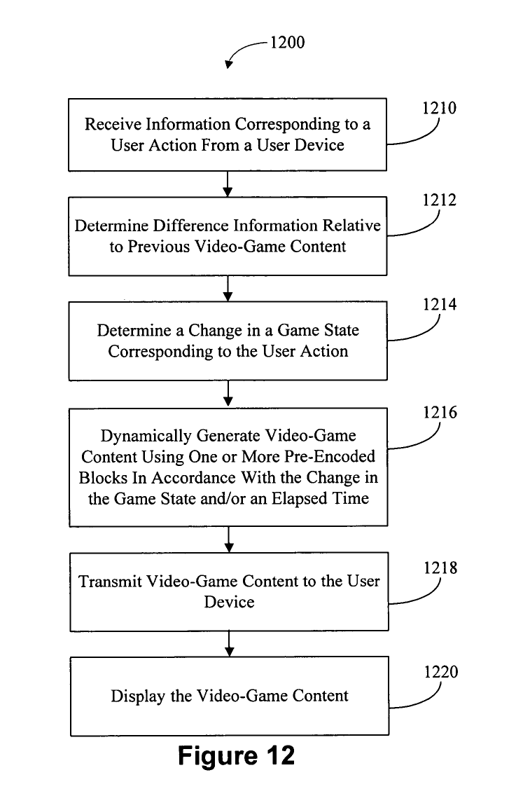

Attention is now directed towards several embodiments of methods of operations for utilizing the improved video-game system. FIG. 12 is a flow diagram illustrating an embodiment of a process in a video-game system 1200. Information corresponding to a user action is received from a user device (1210). Difference information relative to previous video-game content is determined (1212). A change in a game state corresponding to the user action is determined (1214). Video-game content is dynamically generated using one or more pre-encoded blocks in accordance with the change in the game state and/or an elapsed time, for example, since a previous version of the video-game content was dynamically generated (1216). Video-game content is transmitted to the user device (1218). The video-game content is displayed (1220). The flow diagram 1200 may include fewer operations or additional operations. In addition, two or more operations may be combined and/or the order of the operations may be changed.

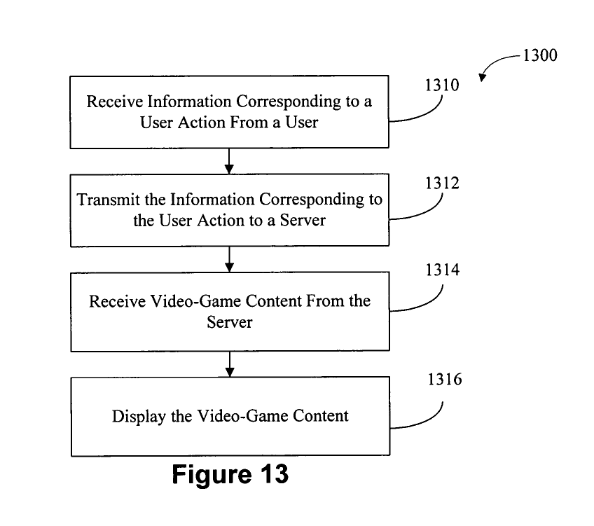

FIG. 13 is a flow diagram illustrating an embodiment of a process in a video-game system 1300. Information corresponding to a user action is received from a user (1310). The information corresponding to the user action is transmitted to a server (1312). Video-game content is received from the server (1314). The video-game content is displayed (1316). The flow diagram 1300 may include fewer operations or additional operations. In addition, two or more operations may be combined and/or the order of the operations may be changed.

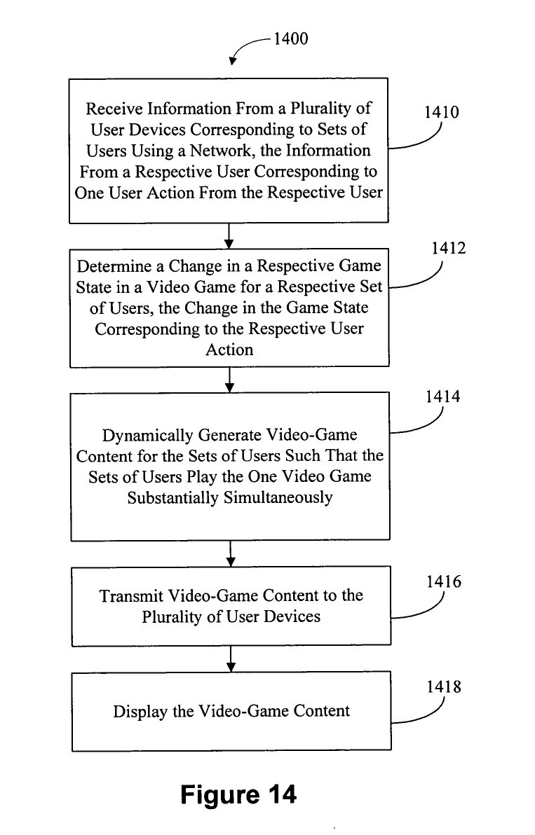

FIG. 14 is a flow diagram illustrating an embodiment of a process in a video-game system 1400. Information from a plurality of user devices corresponding to sets of users using a network is received (1410). The information from a respective user corresponds to one user action from the respective user. A change in a respective game state in a video game for a respective set of users is determined (1412). The change in the game state corresponds to the respective user action. Video-game content for the sets of users is dynamically generated such that the sets of users play the one video game substantially simultaneously (1414). Video-game content is transmitted to the plurality of user devices (1416). The video-game content is displayed (1418). The flow diagram 1400 may include fewer operations or additional operations. In addition, two or more operations may be combined and/or the order of the operations may be changed.

The system and method described may be implement in hardware and/or software. Instructions may be implement in a high-level procedural language, an object-oriented programming language or in an assembly or machine language. The programming language may be compiled or interpreted. In addition, general purpose and special purpose micro-processors, as well as application specific integrated circuits may be utilized.

The foregoing descriptions of specific embodiments of the present invention are presented for purposes of illustration and description. They are not intended to be exhaustive or to limit the invention to the precise forms disclosed. Rather, it should be appreciated that many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. An interactive video-game system, comprising:
a network;
a plurality of user devices coupled to the network, wherein each user device is configured to receive information corresponding to at least one user action for a respective user, to transmit the information corresponding to at least the one user action for the respective user using the network, to receive video-game content using the network and to display the video-game content; and
a server coupled to the network, wherein the server is configured to receive the information corresponding to at least the one user action for the respective user from one or more of the plurality of user devices and to transmit the video-game content, the server including:
a memory storing a video game; and
a controller configured to execute the video game such that sets of users play the video game substantially simultaneously, wherein a respective set of users comprises one or more users, and wherein each set of users has a respective game state for the video game.

2. The system of claim 1, wherein the controller is configured to execute one or more instances of the video game, wherein each respective instance of the video game executed by the controller maintains a plurality of the respective game states.

3. The system of claim 1, wherein video-game content is transmitted from the server to a respective user device in the plurality of user devices using time domain multiplexing.

4. The system of claim 1, wherein a maximum number of sets of users that substantially simultaneously play the video game is at least 100.

5. The system of claim 1, wherein the memory further stores a plurality of pre-encoded blocks, wherein the pre-encoded blocks are compressed and correspond to subsections of a frame of video for the video game.

6. The system of claim 5, wherein the controller dynamically generates the video-game content using one or more of the pre-encoded blocks in accordance with a change in the respective game state corresponding to at least the one user action of the respective user in the respective set of users, and wherein current video-game content transmitted from the server to the respective user device includes at least difference information relative to previous video-game content transmitted from the server to the respective user device.

7. A method of playing a video game, comprising:
receiving information from a plurality of user devices corresponding to sets of users using a network, wherein the information from a respective user device corresponds to at least one user action from a respective user;
generating video-game content for the sets of users such that the sets of users play a video game substantially simultaneously, wherein a respective set of users comprises one or more users, and wherein each set of users has a respective game state for the video game,
transmitting video-game content to the plurality of user devices; and
displaying the video game content.

8. An interactive video-game system, comprising:
a network;
a user device coupled to the network, wherein the user device is configured to receive information corresponding to at least one user action, to transmit the information corresponding to at least the one user action using the network, to receive video-game content using the network and to display the video-game content; and
a server coupled to the network, wherein the server is configured to receive the information corresponding to at least the one user action and to transmit the video-game content, the server including:
a memory storing a video game and a plurality of pre-encoded blocks, wherein the pre-encoded blocks are compressed and correspond to subsections of a frame of video for the video game; and
a controller configured to execute the video game and to dynamically generate the video-game content using one or more of the pre-encoded blocks in accordance with a change in a game state corresponding to at least the one user action, wherein current video-game content transmitted from the server to the user device includes at least difference information relative to previous video-game content transmitted from the server to the user device.

9. The system of claim 8, wherein each of the pre-encoded blocks comprises a macro block.

10. The system of claim 8, wherein the information corresponding to at least the one user action is communicated in the network using an out-of-band communications sub-channel.

11. The system of claim 8, wherein the server is in a headend unit in a cable television system.

12. The system of claim 11, wherein the user device is a set-top box.

13. The system of claim 8, wherein video-game content is displayed in real time as updates corresponding to a subset of a full frame of video are received by the user device.

14. The system of claim 8, wherein the video-game system is configured to assign a network address to the user device when order information corresponding to the video game is received.

15. The system of claim 8, wherein a data rate corresponding to the video game content transmitted from the server to the user device using the network is bounded between a pre-determined lower limit and a pre-determined upper limit.

16. The system of claim 15, wherein the video-game content dynamically generated by the controller includes null blocks to ensure that the data rate is greater than or equal to the pre-determined lower limit.

17. The system of claim 8, wherein the pre-encoded blocks are MPEG compatible.

18. The system of claim 8, wherein the pre-encoded blocks are encoded using a discrete cosine transformation (DCT).

19. The system of claim 18, wherein dynamic generation of the video-game content includes interrelating DCT coefficients corresponding to two or more pre-encoded blocks in real time.

20. The system of claim 8, further comprising one or more additional user devices, wherein each user device receives and displays video-game content corresponding to at least the respective user.

21. The system of claim 20, wherein two or more users simultaneously and independently play a single instance of the video game and share at least a subset of the pre-coded blocks, and wherein each of the two or more users has a corresponding respective game state for the video game.

22. An interactive video-game system, comprising:
a network;
a user means, coupled to the network, for receiving information corresponding to at least one user action, transmitting the information corresponding to at least the one user action using the network, receiving video-game content using the network and displaying the video-game content; and
a server means, coupled to the network, for receiving the information corresponding to at least the one user action and transmitting the video-game content, the server means including:
a memory mechanism for storing a video game and a plurality of pre-encoded blocks, wherein the pre-encoded blocks are compressed and correspond to subsections of a frame of video for the video game; and
a controller mechanism for executing the video game and dynamically generating the video-game content using one or more of the pre-encoded blocks in accordance with a change in a game state corresponding to at least the one user action, wherein current video-game content transmitted from the server to the user device includes at least difference information relative to previous video-game content transmitted from the server to the user device.

23. A method of playing a video game, comprising:
receiving information corresponding to at least one user action from a user device using a network;
determining a change in a game state for a user in accordance with at least the one user action;
dynamically generating video-game content using at least one of a plurality of pre-encoded blocks in accordance with the change in the game state, wherein the pre-encoded blocks are compressed and correspond to subsections of a frame of video for a video game and the video-game content includes at least difference information relative to previous video-game content transmitted to the user device;
transmitting video-game content to the user device; and
displaying the video game content.
